(19) United States
(12) Patent Application Publication
(10) Pub. No.: US 2007/0139470 A1
(43) Pub. Date: Jun. 21, 2007

(54) Array printhead and inkjet image forming apparatus having the same

(75) Inventor: Young-su Lee, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/524,187

(22) Filed: Sep. 21, 2006

(30) Foreign Application Priority Data
Dec. 21, 2005 (KR) 2005-126930

(51) Int. Cl. B41J 2/21

(52) U.S. Cl. 347/43

(57) ABSTRACT

An array printhead and an image forming apparatus having the same. The array printhead includes a first member, a second member, and a third member. The first, second, and third members sequentially overlap and couple to each other. The first member supplies ink of different colors to the second member and the second member separately receives the ink of different colors supplied from the first member and allows the ink to flow to the third member. The third member includes a plurality of head chips. A plurality of supply grooves are formed in a side of the third member on which the plurality of head chips are mounted. The plurality of supply grooves includes a plurality of supply holes that provide the ink of different colors supplied from the second member to the plurality of head chips. The plurality of supply holes are located on an axis different from axes of other adjacent supply holes with respect to a direction perpendicular to a width direction of a print medium.

### CROSS-REFERENCE TO RELATED APPLICATIONS

This application claims priority under 35 U.S.C. §119 from Korean Patent Application No. 10-2005-0126930, filed on Dec. 21, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus having an array printhead including a nozzle unit of a length that corresponds to the width of paper.

2. Description of the Related Art

An inkjet image forming apparatus is an apparatus which fires ink using a printhead (i.e., a shuttle type printhead) spaced apart a predetermined interval from the front surface of a sheet of paper and which reciprocates in a direction (i.e., the width direction of the sheet of paper) perpendicular to a delivery direction of the sheet of paper to form an image on the sheet of paper. The printhead includes a nozzle unit having a plurality of nozzles to eject ink.

Recently, an attempt has been made to realize high-speed printing by using a printhead (i.e., an array printhead) having a nozzle unit of a length that corresponds to the width of the sheet of paper instead of the shuttle type printhead which reciprocates in the width direction of the sheet of paper. Since the printhead is fixed and only the sheet of paper is moved in the array printhead inkjet image forming apparatus, a driving mechanism is simple and high-speed printing may be realized.

The array printhead may supply ink of a plurality of colors to form a color image. For that purpose, a plurality of supply channels through which ink of the plurality of colors is supplied may be formed at a length that corresponds to the width of the sheet of paper in a lower surface of the array printhead.

However, as described above, since the supply channels which supply ink in the array printhead are formed with a length that corresponds to the width of the sheet of paper, the array printhead is difficult to manufacture and a degree of planarization needs to be managed to properly mount a head chip on the array printhead.

### SUMMARY OF THE INVENTION

The present general inventive concept provides an array printhead having ink supply channels, and an inkjet image forming apparatus having the same, capable of mounting a plurality of head chips in a plurality of lines and allowing ink of four colors to be supplied to each of the plurality of head chips.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an array printhead to print an image on a print medium, the array printhead including a first member to supply ink of different colors, a second member to separately receive the ink of different colors supplied from the first member, a third member having a plurality of supply grooves each corresponding to each of a plurality of head chips, the plurality of supply grooves being formed in one side of the third member where the plurality of head chips are mounted, and having a plurality of supply holes each supplying the ink of different colors supplied from the second member, the plurality of supply holes being formed in corresponding ones of the plurality of supply grooves so as to independently supply the ink of different colors to each of the plurality of head chips, wherein the first, second, and third members sequentially overlap and couple to each other, and each of the plurality of supply holes is located on an axis line different from axis lines of adjacent others of the plurality of supply holes in a direction perpendicular to a width direction of the print medium.

The foregoing and/or other aspects of the present general inventive concept may be achieved by providing an inkjet image forming apparatus having a paper feeding element feeding paper in one direction and an array printhead ejecting ink onto the paper to form an image, the array printhead including a first member to supply ink of different colors, a second member to separately receive the ink of different colors supplied from the first member, a third member having a plurality of supply grooves each corresponding to each of a plurality of head chips, the plurality of supply grooves being formed in one side of the third member where the plurality of head chips are mounted, and having a plurality of supply holes each supplying the ink of different colors supplied from the second member, the plurality of supply holes being formed in corresponding ones of the plurality of supply grooves so as to independently supply the ink of different colors to each of the plurality of head chips, wherein the first, second, and third members sequentially overlap and couple to each other, and each of the plurality of supply holes is located on an axis line different from axis lines of adjacent others of the plurality of supply holes in a direction perpendicular to a width direction of the paper.

The foregoing and/or other aspects of the present general inventive concept may be achieved by providing an array printhead usable in an image forming apparatus, including an array printhead usable in an image forming apparatus, including a member to receive ink of different colors in a first direction, and having a plurality of inlet holes spaced apart from each other in a second direction to receive the corresponding ink of different colors in the first direction, a plurality of ink channels to communicate with corresponding ones of the plurality of the inlet holes and to direct the corresponding ink of the different colors in the second direction, a plurality of channel groove groups disposed in the second direction, each group having channel grooves to communicate with corresponding ones of the plurality of ink channels and to direct the corresponding ink of different colors in a third direction, and a plurality of head chips disposed in the second direction to correspond to respective ones of the channel groove groups, each of the plurality of head chips having a plurality of nozzle lines disposed in the third direction, each nozzle line receiving the corresponding ink of different colors from corresponding ones of the channel groove.

The member may include a plurality of supply holes formed on corresponding ones of the channel grooves of the each channel groove group, and a plurality of supply grooves disposed in the second direction to correspond to corresponding nozzle lines to direct the corresponding ink of different colors to the corresponding nozzle lines.

These and/or other aspects and advantages of the present general inventive concept will become apparent and more readily appreciated from the following description of the embodiments, taken in conjunction with the accompanying drawings of which:

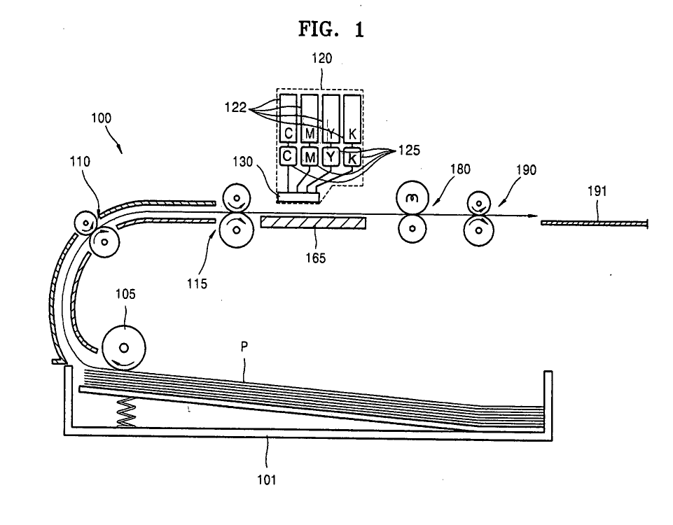

FIG. 1 is a view illustrating an inkjet image forming apparatus according to an embodiment of the present general inventive concept;

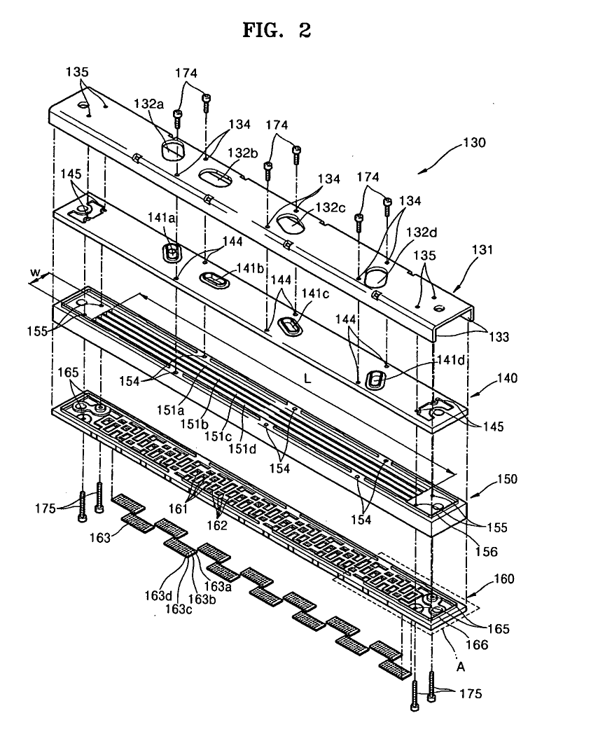

FIG. 2 is an exploded perspective view illustrating an array printhead usable with an image forming apparatus according to an embodiment the present general inventive concept;

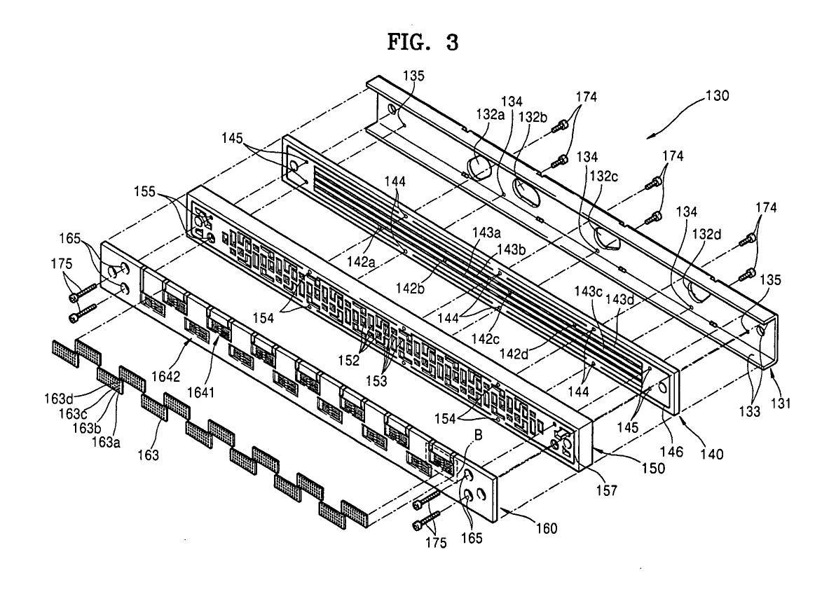

FIG. 3 is an exploded perspective view illustrating a backside of the array printhead of FIG. 2;

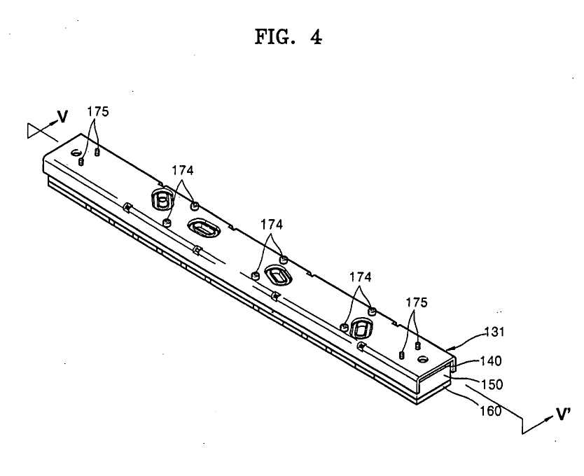

FIG. 4 is a perspective view illustrating the array printhead of FIG. 2;

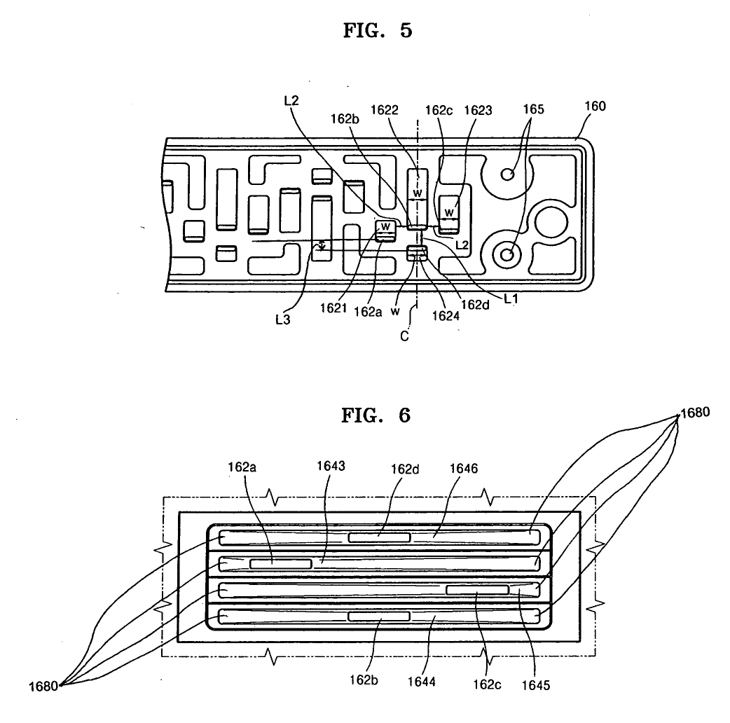

FIG. 5 is a partial enlarged view illustrating a portion A of FIG. 2;

FIG. 6 is a partial enlarged view illustrating a portion B of FIG. 3;

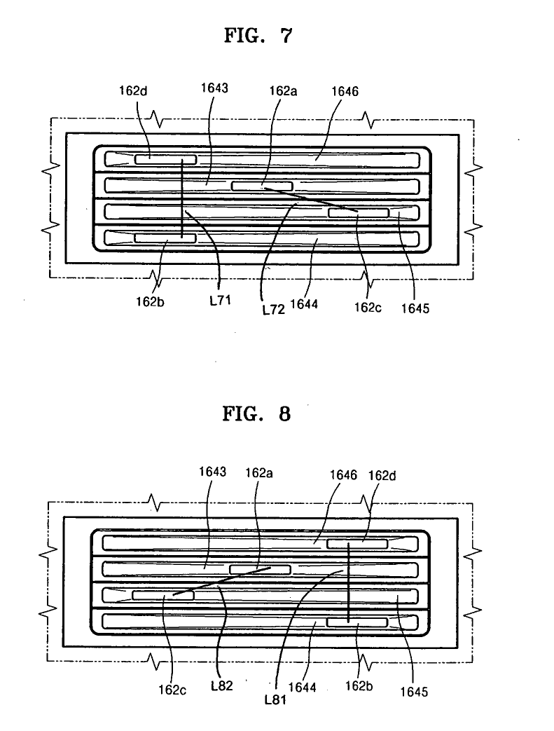

FIG. 7 is a partial enlarged view illustrating a modification of the portion B of FIG. 3;

FIG. 8 is a partial enlarged view illustrating another modification of the portion B of FIG. 3; and

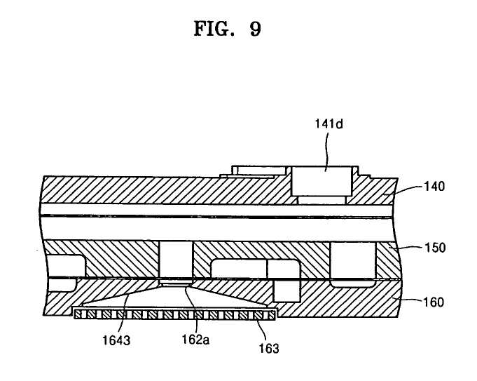

FIG. 9 illustrates a sectional view taken along a line V-V′ of FIG. 4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Referring to FIG. 1, an inkjet image forming apparatus 100 includes a paper feeding element to feed a printing medium, such as a sheet of paper P, in one direction and an array printhead 130 to eject ink onto the paper P to form an image on the paper P.

The paper feeding element may include feeding rollers 110 to feed the paper P such that the paper P passes through a paper path below the array printhead 130 and discharge rollers 190 to discharge the paper P on which the image is formed by ejection of the ink to a paper-discharging tray 191. The paper feeding element may also include a paper pickup roller 105 to pick up the paper P stacked in the paper-supply cassette 101.

Each of the feeding rollers 110 and the discharge rollers 190 has a pair of rollers which may include a drive roller and a driven roller installed to press against each other, and the paper P progresses between contact surfaces where the drive roller and the driven roller of the respective feeding and discharge rollers are pressed to contact each other. A reference numeral 115 is a pair of registration rollers to align the paper P in order to form the image on a desired portion of the paper P.

The inkjet image forming apparatus 100 includes the paper-supply cassette 101 in which the paper P on which the image is to be printed is stacked, and the pickup roller 105 to pick up the paper P sheet by sheet stacked in the paper-supply cassette 101. Also, the inkjet image forming apparatus 100 further includes a dryer 180 to dry the image formed on the paper P by the ejection of ink. Since the inkjet image forming apparatus 100 having the array printhead 130 has a high printing speed, the paper P may not be sufficiently dried as it is successively stacked on the paper-discharging tray 191, which may cause ink spreading. The drier 180 prevents a printing defect due to the ink spreading by rapidly drying an image.

An ink cartridge 120 is located between the registration rollers 115 and the drier 180.

The ink cartridge 120 includes four ink tanks 122C, 122M, 122Y, and 122K which respectively receive ink of four colors of cyan (C), magenta (M), yellow (Y), and black (K), four negative pressure regulators 125C, 125M, 125Y, and 125K, and the array printhead 130 therein.

The negative pressure regulators 125C, 125M, 125Y, and 125K regulate negative pressures of ink which flows to the array printhead 130 from the four ink tanks 122C, 122M, 122Y, and 122K to prevent air bubbles from penetrating into the inside of the array printhead 130 (refer to FIG. 3) or prevent the ink from leaking out unnecessarily.

A platen 165 is located below the array printhead 130 to support the paper P containing the image thereon and to pass the paper P through the paper path below the array printhead 130. By use of the platen 165, a uniform interval is maintained between the array printhead 130 and the paper P as it passes through the paper path below the array printhead 130.

Referring to FIGS. 2 and 3, the array printhead 130 includes a support member 131, a first member 140, a second member 150, and a third member 160, which sequentially overlap and couple with each other in a first direction.

The first, second, and third members 140, 150, and 160 are respectively formed by molding liquid crystal polymer, which is a polymer resin. The liquid polymer has excellent molding properties, excellent chemical durability, and a high resistance against twisting due to external forces. The liquid polymer is a material having excellent measurement stability and thus is appropriate for the printhead 130 which requires a high degree of planarization and a high degree of accuracy in measurement.

The support member 131 includes guide holes 132a, 132b, 132c, and 132d to receive ink of different colors, and first and second coupling holes 134 and 135. The guide holes 132a, 132b, 132c, and 132d are spaced apart by a distance in a second direction having an angle with the first direction.

The first member 140 includes four inlet holes 141a, 141b, 141c, and 141d formed to allow ink of four colors of cyan, magenta, yellow, and black from the four negative pressure regulators 125C, 125M, 125Y, and 125K (refer to FIG. 2) through the guide holes 132a, 132b, 132c, and 132d to flow into an inside of the array printhead 130 (i.e., four channels 151a, 151b, 151c, and 151d of the second member 150). In detail, ink of cyan, magenta, yellow, and black may flow through a first inlet hole 141a, a second inlet hole 141b, a third inlet hole 141c, and a fourth inlet hole 141d, respectively. Four channels 143a, 143b, 143c, and 143d are formed in a lower surface of the first member 140 to separately receive the ink of four colors of C, M, Y, and K, which have flowed in through the four inlet holes 141a, 141b, 141c, and 141d. Through holes 142a, 142b, 142c, and 142d are formed in the respective four channels 143a, 143b, 143c, and 143d to communicate with the four inlet holes 141a, 141b, 141c, and 141d, respectively.

The second member 150 includes the four channels 151a, 151b, 151c, and 151d disposed in a third direction having an angle with the second direction to separately receive ink of four colors of C, M, Y, and K, which has flowed in through the four through holes 142a, 142b, 142c, and 142d, respectively. The channels 151a, 151b, 151c, and 151d are mutually parallel to the width direction of the paper P, i.e., a length direction of the array printhead 130 or a direction perpendicular to a paper feeding direction of the paper P. The four channels 151a, 151b, 151c, and 151d may receive cyan ink, magenta ink, yellow ink, and black ink, respectively. The first angle may be 90 degrees with respect to the second and third angles, and the second angle may be 90 degrees with respect to the third angle.

The four channels 143a, 143b, 143c, and 143d are also formed in a lower surface of the first member 140 in a same pattern as the four channels 151a, 151b, 151c, and 151d formed in an upper surface of the second member 150. With this construction, the channels 143a, 143b, 143c, and 143d of the first member 140 face the four channels 151a, 151b, 151c, and 151d of the second member 150, so that sufficient ink receiving spaces may be provided for the ink of four colors of C, M, Y, and K, respectively.

A rib 156 is protruded from the periphery of the upper surface of the second member 150 and a groove 146 is formed in a periphery of the lower surface of the first member 140 to receive the rib 156 of the second member 150. The rib 156 and the groove 146 serve as references when the first member 140 and the second member 150 are attached to each other. The rib 156 and the groove 146 may suppress bending and twisting of the first member 140 and the second member 150, thereby improving sealing between the first member 140 and the second member 150.

The array printhead 130 may include a plurality of head chips 163 arranged in a zigzag with respect to the width direction of paper (i.e., the length direction of the array printhead 130), so that the head chips 163 form a plurality of head chip lines.

A plurality of head chip mounting parts 1641 and 1642 each constituting the plurality of head chip lines may also be formed in a zigzag in a backside of the third member 160 so that each of the plurality of head chips 163 may be mounted on each of the plurality of head chip mounting parts 1641 and 1642.

A plurality of channel groove groups 161 and 162, each channel groove group serving as a flowing passage of ink that has flowed from the second member 150, may be formed in an upper surface of the third member 160.

To supply ink to the head chip mounting parts 164a and 164b, respectively, the plurality of channel groove groups 161 and 162 of the third member 160 may be repeatedly formed in the length direction of the array printhead 130 to correspond to the arrangement of the head chips 163. That is, the plurality of channel groove groups 161 and 162 may be formed in the zigzag. Therefore, cyan ink, magenta ink, yellow ink, and black ink may be respectively supplied to a first nozzle line 163a, a second nozzle line 163b, a third nozzle line 163c, and a fourth nozzle line 163d formed on the head chip 163 in the second direction. The ink of four colors may be supplied to one chip, so that “1-head chip 4-colors’ can be achieved.

A plurality of second channel groove groups 152 and 153 may also be formed on the lower surface of the second member 150 in a same pattern as a pattern of the channel groove groups 161 and 162 of the third member 160.

A rib 166 may protrude from a periphery of the upper surface of the third member 160 and a second groove 157 may be formed in a periphery of the lower surface of the second member 150 to receive the rib 166. The second rib 166 and the second groove 157 serve as references when the second member 150 and the third member 160 are attached to each other. The second rib 166 and the second groove 157 suppress bending and twisting of the second member 150 and the third member 160, thereby improving sealing between the second member 150 and the third member 160.

Referring to FIGS. 2, 3, and 5, the channel groove group 162 includes four channel grooves 1621, 1622, 1623, and 1624. The channel grooves 1621, 1622, 1623, and 1624 may have a same width W and different lengths. Supply holes 162a, 162b, 162c, and 162d, respectively, which supply ink of four colors to a head chip mounting part 1642, may be formed at ends of the channel grooves 1621, 1622, 1623, and 1624, respectively, to pass through the head chip mounting part 1642. The supply holes 162a, 162b, 162c, and 162d correspond to the first, second, third, and fourth nozzle lines 163a, 163b, 163c, and 163d, respectively.

As illustrated in FIG. 5, assuming that the supply holes 162b and 162d are first supply holes and the supply holes 162a and 162c are second supply holes, the first supply holes 162b and 162d may be spaced apart from each other by a distance L1 in a direction (third direction) perpendicular to a width (second direction) of paper P and located on a same vertical axis line C. The first supply hole 162b may be a horizontal distance L2 away from either of the second supply holes 162a or 162c in the second direction. The first supply hole 162b may also be a vertical distance L3 (where L3=[1/3]*[L1]) away from the second supply hole 162a in the third direction, and may also be the vertical distance L3 from the second supply hole 162c in the third direction. The first supply hole 162d may also be the vertical distance L3 away from the second supply hole 162a and the second supply hole 162c in the third direction. That is, the first supply holes 162b and 162d may be located to face each other on the vertical axis line C (third direction) and may be spaced apart by the distance L1 which is greater than the horizontal distance L2 between either of the second supply holes 162a and 162c and the axis line C in the second direction. The distance L1 between the first supply holes 162b and 162d may also be greater than the vertical distance L3 between individual ones of the second supply holes 162a and 162c and the first supply holes 162b and 162d in the third direction. In other words, the distance L1 may be greater than the horizontal distance L2 in the second direction or the vertical distance L3 in the third direction. The horizontal distance L2 and the vertical distance L3 may be less than the width W.

The second supply holes 162a and 162c may be spaced apart from the first supply holes 162b and 162d by as much as the distance L2 on both sides of the vertical axis line C of the first supply holes 162b and 162d, in a direction (second direction) of the width of the paper P and perpendicular to the vertical axis line C (third direction).

Referring again to FIGS. 2, 3, and 5, the channel grooves 1621, 1622, 1623, and 1624 may be spaced apart from one another by as much as distances L1 and L2 without overlapping one another. Sealant may be coated on spaced portions of the third member 160 between the channel grooves 1621, 1622, 1623, and 1624 in order for coupling of the third member 160 with the second member 150. Since the spaced portions between the channel grooves 1621, 1622, 1623, and 1624 may be symmetrically formed with respect to the first supply holes 162b and 162d, it is possible to uniformly coat the sealant between the channel grooves 1621, 1622, 1623, and 1624. Accordingly, the channel grooves 1621, 1622, 1623, and 1624 and the supply holes 162a, 162b, 162c, and 162d may form supply passages between the second member 150 and the third member 160 which supply the ink of four colors to head chip 163.

As described above, it is possible to provide the supply passages through which ink of different colors may be supplied securely and without being mixed by providing the above arrangement with respect to the supply holes 162a, 162b, 162c, and 162d and the channel grooves 1621, 1622, 1623, and 1624. Also, it is possible to stably secure a bonding space in which an adhesive may be coated so that the third member 160 may be coupled to the second member 150.

Referring to FIGS. 2 and 3, the head chip 163 includes four nozzle lines 163a, 163b, 163c, and 163d formed in parallel to the width direction (second direction) of the paper P to eject the ink of different colors. In detail, cyan ink, magenta ink, yellow ink, and black ink may be respectively supplied to a nozzle line 163a, a nozzle line 163b, a nozzle line 163c, and a nozzle line 163d formed on the head chip 163. Therefore, the ink of four colors is supplied to one chip, so that ‘1-head chip 4-colors’is achieved.

Referring to FIGS. 3, 6 and 9, an embodiment of the present general inventive concept with respect to an arrangement of the portion B of FIG. 3 will be explained. A head mounting part 1642 (FIG. 3) includes a plurality of supply grooves 1643, 1644, 1645, and 1646 formed in parallel to a width direction of paper P. The supply grooves 1643, 1644, 1645, and 1646 supply ink of different colors to corresponding nozzle lines 163a, 163b, 163c, and 163d of the head chip 163 mounted on the head mounting part 1642.

Each of the plurality of supply grooves 1643, 1644, 1645, and 1646 communicates with each of plural channel grooves 1621, 1622, 1623, and 1624 through supply holes 162a, 162b, 162c, and 162d.

The plurality of supply grooves 1643, 1644, 1645, and 1646 may have slopes 1680 formed to be inclined on both sides of the supply holes 162a, 162b, 162c, and 162d along a direction from the supply holes 162a, 162b, 162c, and 162d to a lower surface of the head chip mounting part 1642 (i.e., a direction toward the head chip 163 in FIG. 3). Therefore, as illustrated in FIG. 9 which is a sectional view taken along a line V-V′ of FIG. 4, ink may be supplied through an inlet hole 141d of a first member 140 and through ink supply passages formed by a second member 150 and a third member 160. Then, the ink that has flowed into the supply grooves 1643, 1644, 1645, and 1646 through the supply holes 162a, 162b, 162c, and 162d may be uniformly supplied along inclined portions of the supply grooves 1643, 1644, 1645, and 1646 to the nozzle lines 163a, 163b, 163c, and 163d of the head chip 163.

Referring to FIGS. 7 and 8, the supply holes 162a, 162b, 162c, and 162d are arranged differently from those in FIGS. 5 and 6. That is, referring to FIG. 7, the second supply holes 162a and 162c are arranged to a right side of the first supply holes 162b and 162d. Referring to FIG. 8, the second supply holes 162a and 162c are arranged to a left side of the first supply holes 162b and 162d .

It is possible to stably secure a space on which sealant is coated between the supply holes 162a, 162b, 162c, and 162d with an arrangement where a spaced distance (L71 in FIG. 7 or L81 in FIG. 8) between the first supply holes 162b and 162d is set to be equal to a spaced distance (L72 in FIG. 7 or L82 in FIG. 8) between the second supply holes 162a and 162c.

When the sealant is hardened at a predetermined temperature with the sealant coated between the channel grooves 1621, 1622, 1623, and 1624 of FIG. 5 and the head chip 163 of FIGS. 2, 3, and 9 mounted on the head chip mounting part 1642 of FIG. 3, a gas of high temperature and high pressure is generated. At this point, when the generated gas remains without being exhausted, the gas exerts stress on the head chip 163. Furthermore, stress is added to the head chip 163 due to a difference in linear expansion coefficients during contraction.

Referring to FIGS. 5, 6, 7, and 8, it is possible to prevent the stress from being concentrated on only one portion of the head chip 163 by providing the supply holes 162a, 162b, 162c, and 162d to uniformly distribute the stress due to the gas generated when the sealant is hardened over the entire head chip 163.

Referring to FIGS. 2, 3, and 4, channel groove groups 152 and 153 may also be formed in a lower surface of the second member 150 in a same pattern as a pattern of the channel groove groups 161 and 162 formed in an upper surface of the third member 160.

A rib 166 (FIG. 2) protrudes from a periphery of the upper surface of the third member 160 and a groove 157 (FIG. 3) to receive the rib 166 may be formed in a periphery of the lower surface of the second member 150. The rib 166 and the groove 157 allow the second member 150 and the third member 160 to be cooperatively bonded to each other. When the sealant is coated on a space between the channel groove groups 161 and 162 of the third member 160 and the channel groove groups 152 and 153 of the second member 150 to bond the third member 160 to the second member 150, the third member 160 and the second member 150 are closely attached to each other and the channel groove groups 161 and 162 of the third member 160 and the channel groove groups 152 and 153 of the second member 150 constitute ink supply channels or supply passages.

The first, second, and third members 140, 150, and 160 are vertically coupled to a support member 131 using a coupling element. For that purpose, as illustrated in FIGS. 2, 3, and 4, the coupling element may include the first coupling parts 174 that sequentially couple the support member 131, the first member 140, and the second member 150 vertically from a first side of the support member 131, and second coupling parts 175 that sequentially couple the third member 160, the second member 150, the first member 140, and the support member 131 vertically from a second side of the support member 131.

The support member 131 includes the first and second coupling holes 134 and 135. The first member 140 includes first and second coupling holes 144 and 145, the second member 150 includes first and second coupling holes 154 and 155, and the third member 160 includes second coupling holes 165. Accordingly, the first coupling part 174 is coupled in the first coupling holes 134, 144, and 154, and the second coupling part 175 is coupled in the second coupling holes 135, 145, 155, and 165.

As described above, the array printhead according to the present general inventive concept has the following effects.

The present general inventive concept may provide a uniform width of a channel groove for each color to swiftly supply ink.

The present general inventive concept may provide maximum adhesive area to enhance adhesive force when bonding is performed with an adhesive.

A plurality of supply holes may be arranged such that stress is not concentrated only at one portion of a head chip.

Since adhesive force is reinforced, mixing of colors and leakage of ink may be prevented.

An adhesive surface is formed in a uniform pattern, so that an adhesive process may be easily performed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An array printhead to print an image on a print medium, the array printhead comprising:
a first member to supply ink of different colors;
a second member to separately receive the ink of different colors supplied from the first member;
a third member having a plurality of supply grooves each corresponding to each of a plurality of head chips, the plurality of supply grooves being formed in one side of the third member where the plurality of head chips are mounted, and having a plurality of supply holes each supplying the ink of different colors supplied from the second member, the plurality of supply holes being formed in corresponding ones of the plurality of supply grooves so as to independently supply the ink of different colors to each of the plurality of head chips,
wherein the first, second, and third members sequentially overlap and couple to each other, and each of the plurality of supply holes is located on an axis line different from axis lines of adjacent others of the plurality of supply holes in a direction perpendicular to a width direction of the print medium.

2. The array printhead of claim 1, wherein the plurality of supply holes comprise:
two first supply holes spaced apart from each other by a spaced distance in a direction perpendicular to a width of the print medium and located on a same axis line; and
two second supply holes each spaced apart from the axis line by a second spaced distance on both sides of the axis line of the two first supply holes.

3. The array printhead of claim 1, wherein the plurality of supply holes comprise:
two first supply holes spaced apart from each other by a spaced distance in a direction perpendicular to a width of the print medium and located on a same axis line; and
two second supply holes disposed opposite to each other and both on a same side of the axis line of the first supply holes and spaced apart from each other on an axis line by as much as the spaced distance between the first supply holes.

4. The array printhead of claim 3, wherein the plurality of supply grooves are formed in each of channel groove groups, and the plurality of supply holes communicate with each of the plurality of channel groove groups and are formed at a same width in a side of the third member overlapping the second member.

5. The array printhead of claim 4, wherein the plurality of channel groove groups are spaced a same distance from each other in the width direction of the print medium.

6. The array printhead of claim 1, wherein the plurality of supply grooves are formed in each of channel groove groups to correspond to each of the plurality of head chips each having a plurality of nozzle lines, and the plurality of supply holes communicate with each of a plurality of channel groove groups formed at a same width in a side of the third member overlapping the second member.

7. The array printhead of claim 1, wherein each of the plurality of supply grooves comprises a slope formed on both sides of each of the plurality of supply holes along a direction from each of the plurality of supply holes to each of the plurality of head chips, so that ink that flows into each of the plurality of supply holes is uniformly supplied across an entire length of each of the plurality of supply grooves.

8. An inkjet image forming apparatus having a paper feeding element feeding paper in one direction and an array printhead ejecting ink onto the paper to form an image, the array printhead comprising:
a first member to supply ink of different colors;
a second member to separately receive the ink of different colors supplied from the first member;
a third member having a plurality of supply grooves each corresponding to each of a plurality of head chips, the plurality of supply grooves being formed in one side of the third member where the plurality of head chips are mounted, and having a plurality of supply holes each supplying the ink of different colors supplied from the second member, the plurality of supply holes being formed in corresponding ones of the plurality of supply grooves so as to independently supply the ink of different colors to each of the plurality of head chips,
wherein the first, second, and third members sequentially overlap and couple to each other, and each of the plurality of supply holes is located on an axis line different from axis lines of adjacent others of the plurality of supply holes in a direction perpendicular to a width direction of the paper.

9. The inkjet image forming apparatus of claim 8, wherein the plurality of supply holes comprise:
two first supply holes spaced apart from each other by a spaced distance in a direction perpendicular to a width of the paper and located on a same axis line; and
two second supply holes each spaced apart from the axis line by a second spaced distance both sides of the axis line of the two first supply holes.

10. The inkjet image forming apparatus of claim 8, wherein the plurality of supply holes comprise:
two first supply holes spaced apart from each other by a spaced distance in a direction perpendicular to the width of the print medium and located on a same axis line; and
two second supply holes disposed opposite to each other and both on a same side of the axis line of the first supply holes and spaced apart from each other on an axis line by as much as the spaced distance between the first supply holes.

11. The inkjet image forming apparatus of claim 10, wherein the plurality of supply grooves are formed in each of channel groove groups, and the plurality of supply holes communicate with each of the plurality of channel groove groups and are formed at a same width in a side of the third member overlapping the second member.

12. The inkjet image forming apparatus of claim 11, wherein the plurality of channel groove groups are spaced a same distance from each other in the width direction of the print medium.

13. The inkjet image forming apparatus of claim 8, wherein the plurality of supply grooves are formed in each of channel groove groups to correspond to each of the plurality of head chips each having a plurality of nozzle lines, and the plurality of supply holes communicate with each of a plurality of channel groove groups formed at a same width in a side of the third member overlapping the second member.

14. The inkjet image forming apparatus of claim 8, wherein each of the plurality of supply grooves comprises a slope formed on both sides of each of the plurality of supply holes along a direction from each of the plurality of supply holes to each of the plurality of head chips, so that ink that flows into each of the plurality of supply holes is uniformly supplied across an entire length of each of the plurality of supply grooves.

15. An array printhead usable in an image forming apparatus, comprising:
a member to receive ink of different colors in a first direction, and having a plurality of inlet holes spaced apart from each other in a second direction to receive the corresponding ink of different colors in the first direction, a plurality of ink channels to communicate with corresponding ones of the plurality of the inlet holes and to direct the corresponding ink of the different colors in the second direction, a plurality of channel groove groups disposed in the second direction, each group having channel grooves to communicate with corresponding ones of the plurality of ink channels and to direct the corresponding ink of different colors in a third direction; and
a plurality of head chips disposed in the second direction to correspond to respective ones of the channel groove groups, each of the plurality of head chips having a plurality of nozzle lines disposed in the third direction, each nozzle line receiving the corresponding ink of different colors from corresponding ones of the channel grooves.

16. The array printhead of claim 15, wherein the channel grooves have different lengths in the third direction.

17. The array printhead of claim 15, wherein the channel grooves have a same width in the second direction.

18. The array printhead of claim 15, wherein a number of the channel grooves of each channel groove group is a same as a number of different colors.

19. The array printhead of claim 15, wherein the plurality of channel groove groups are arranged in a zigzag pattern with respect to a center line of the member parallel to the second direction, and the channel grooves of one of the plurality of channel groove groups are spaced apart from the channel grooves of the adjacent ones of the plurality of channel groove groups by a distance.

20. The array printhead of claim 15, wherein the channel grooves are spaced apart from each other by a distance.

21. The array printhead of claim 15, wherein when the channel grooves comprise first, second, third, and fourth channel grooves, the first, second, third, and fourth channel grooves have first, second, third, and fourth lengths in the third direction.

22. The array printhead of claim 15, wherein when the channel grooves comprise first, second, third, and fourth channel grooves, the second and fourth channel grooves are disposed on a line of the each channel groove group parallel to the third direction, and the first and third channel grooves are disposed on lines of the each channel groove group different from the first line.

23. The array printhead of claim 22, wherein the line is a center line of the each channel groove group.

24. The array printhead of claim 15, wherein the member comprises:
a plurality of supply holes formed on corresponding ones of the channel grooves of the each channel groove group; and
a plurality of supply grooves disposed in the second direction to correspond to corresponding nozzle lines to direct the corresponding ink of different colors to the corresponding nozzle lines.

25. The array printhead of claim 24, wherein each nozzle line comprises a plurality of nozzles to receive the corresponding ink from the corresponding supply group through the corresponding supply hole.

26. The array printhead of claim 24, wherein the plurality of supply holes are disposed on a plurality of lines of each head chip parallel to the third direction.

27. The array printhead of claim 24, wherein the plurality of supply holes comprise first, second, third, and fourth supply holes, disposed on first, second, third, and fourth lines parallel to the third direction so that stress is not concentrated in a portion of the head chip.

28. The array printhead of claim 24, wherein at least two of the supply holes are disposed on a same line parallel to the third direction.

29. The array printhead of claim 24, wherein at least two of the supply holes are disposed opposite to a line parallel to the third direction.

30. The array printhead of claim 24, wherein each supply groove comprises first and second slopes inclined from the supply hole toward ends of the nozzle line of the head chip.

31. The array printhead of claim 30, wherein the first and second slopes have first and second lengths in the second direction.

32. The array printhead of claim 30, wherein the first and second slopes have first and second inclination angles with respect to one of the second direction and the first direction.

33. The array printhead of claim 30, wherein the supply groove has the same length as the nozzle line in the second direction to distribute the ink from the supply hole to the nozzles of the nozzle line.

34. The array printhead of claim 24, wherein the supply holes have a length shorter than that of the channel groove in the second direction.

35. The array printhead of claim 24, wherein the supply holes are disposed at one end of the channel groove in the third direction.

36. The array printhead of claim 24, wherein the plurality of supply holes extend in the second direction and each have a same width.

37. The array printhead of claim 36, wherein the plurality of supply holes comprise:
two first supply holes a first predetermined distance apart on an axis in the third direction which is perpendicular to the second direction; and
two second supply holes a second predetermined distance apart in the second direction.

38. The array printhead of claim 37, wherein the first predetermined distance is greater than the second predetermined distance.

39. The array printhead of claim 37, wherein the two second supply holes are located on opposite sides of the axis.

40. The array printhead of claim 37, wherein the two second supply holes are located on a same side of the axis.
